(19) United States
(12) Patent Application Publication
(10) Pub. No.: US 2024/0139702 A1
(43) Pub. Date: May 2, 2024

(54) PASSIVE TEMPERATURE CONTROL IN CYCLIC FLOW REACTORS

(71) Applicant: EXXONMOBIL TECHNOLOGY AND ENGINEERING COMPANY, Annandale, NJ (US)

(72) Inventors: Anastasios I. SKOULIDAS, Pittstown, NJ (US); Anjaneya S. Kovvali, Herndon, VA (US); Brian M. Moreno, New York, NY (US); Ashish B. Mhadeshwar, Garnet Valley, PA (US); Everett J. O'Neal, Spring, TX (US)

(21) Appl. No.: 18/499,500

(22) Filed: Nov. 1, 2023

Related U.S. Application Data
(60) Provisional application No. 63/505,756, filed on Jun. 2, 2023.
(60) Provisional application No. 63/381,951, filed on Nov. 2, 2022.

(51) Int. Cl. B01J 19/24; B01J 19/00; C01B 3/26

(52) U.S. Cl. CPC B01J 19/2485; B01J 19/0013; B01J 19/0066; C01B 3/26; C01B 2203/0227; C01B 2203/1235

(57) ABSTRACT

Systems and methods are provided for improving control of the temperature profile in a cyclic flow reactor, such as a reverse flow reactor, during operation. The improved temperature control is achieved in part based on inclusion of regions having reduced or minimized catalyst density with increased volumetric heat capacity within the reaction zone of the reactor. This improved control over the temperature profile is achieved while reducing or minimizing any loss of reaction capacity due to lowering the amount of catalyst in the reaction zone.

### CROSS-REFERENCE TO RELATED APPLICATIONS AND PRIORITY CLAIM

This Non-Provisional patent application claims priority to U.S. Provisional Patent Application No. 63/505,756, filed Jun. 2, 2023, and titled “Passive Temperature Control In Cyclic Flow Reactors” and U.S. Provisional Patent Application No. 63/381,951, filed Nov. 2, 2022, and titled “Reverse Flow Reactor With Integrated Partial Oxidation”, the entire contents of which is incorporated herein by reference.

### FIELD OF THE INVENTION

Methods are provided for improving temperature control in cyclic flow reactors, such as reverse flow reactors.

### BACKGROUND OF THE INVENTION

Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step. U.S. Pat. Nos. 7,815,873 and 8,754,276 provide examples of using reverse flow reactors to perform various endothermic processes in a cyclic reaction environment.

Due in part to the ability to perform direct heating of the interior surfaces of a reverse flow reactor while maintaining high purity in the resulting hydrogen product, reverse flow reactors have the potential to provide substantial advantages over conventional steam reforming configurations. However, some practical challenges remain. For example, one of the difficulties with using a reverse flow reactor for reforming is that the reaction environment is cycled rapidly at elevated temperatures. To achieve the highest reforming yields, peak temperatures of 1100° C. or more may be needed. However, exposing reforming catalysts and/or catalyst systems to such elevated temperatures as part of cyclic reaction environment can potentially result in degradation of the catalyst.

Another potential difficulty is related to the limited options for controlling the temperature profile at specific locations within a reactor. Reverse flow reactors have several options for performing overall temperature control. For example, the magnitude of the flow rates during the exothermic and endothermic processes, as well as the ratio of those flow rates, can be used to control the peak temperature in the reactor and/or the location of the peak temperature. However, the qualitative shape of the temperature profile in the reactor remains similar as the flow rates are modified.

### SUMMARY OF THE INVENTION

In an aspect, a reverse flow reactor system is provided. The system includes a reaction zone having a reactant inlet, a flue gas outlet, and a plurality of regions. The plurality of regions include a first region having a first catalyst density and a first volumetric heat capacity, and a second region having a second catalyst density and a second volumetric heat capacity. The second catalyst density can be 20% or less of the first catalyst density. Optionally, a ratio of the second volumetric heat capacity to the first volumetric heat capacity can be 1.5 or more. The system further includes a mixing zone adjacent to the reaction zone. The reaction zone can include at least one reaction zone flow path providing fluid communication between the reactant inlet and the mixing zone. Additionally, the system can include a recuperation zone adjacent to the mixing zone. The mixing zone can provide fluid communication between the reaction zone and the recuperation zone. The recuperation zone can include a fuel inlet, an oxidant inlet, and a reaction effluent outlet.

In another aspect, a reverse flow reactor system is provided. The system includes a reaction zone having a reactant inlet, a flue gas outlet, and a plurality of regions. The plurality of regions include a first region having a first catalyst and a first volumetric heat capacity, and a second region having a second catalyst different from the first catalyst and a second volumetric heat capacity. Optionally, a ratio of the second volumetric heat capacity to the first volumetric heat capacity can be 1.5 or more. The system further includes a mixing zone adjacent to the reaction zone. The reaction zone can include at least one reaction zone flow path providing fluid communication between the reactant inlet and the mixing zone. Additionally, the system can include a recuperation zone adjacent to the mixing zone. The mixing zone can provide fluid communication between the reaction zone and the recuperation zone. The recuperation zone can include a fuel inlet, an oxidant inlet, and a reaction effluent outlet.

In still another aspect, a method for converting hydrocarbons in a reverse flow reactor is provided. The method includes mixing a fuel flow and a first O₂-containing flow in a mixing zone of a reactor system to form a mixture having an O₂ content of 0.1 vol % or more. The reactor system can include a reforming zone, a mixing zone adjacent to the reforming zone, and a recuperation zone adjacent to the mixing zone, with the mixing zone providing fluid communication between the reaction zone and the recuperation zone. The method further includes reacting the mixture to heat one or more surfaces in the reforming zone to a reforming temperature, at least a portion of the reforming zone containing a reforming catalyst. Additionally, the method includes exposing a reactant stream containing one or more hydrocarbons to the reforming catalyst in the reforming zone under reforming conditions to form a reforming effluent. A direction of flow of the reactant stream can be reversed relative to a direction of flow for the mixture. The reaction zone can include a plurality of regions. The plurality of regions can include a first region of the plurality of regions having a first catalyst density of a first catalyst and a first volumetric heat capacity, and a second region having a second catalyst density and a second volumetric heat capacity. The second catalyst density can be 20% or less of the first catalyst density. A ratio of the second volumetric heat capacity to the first volumetric heat capacity can be 1.5 or more.

### BRIEF DESCRIPTION OF THE DRAWINGS

FIG. 1 shows an example of a reaction system during a reaction step.

FIG. 2 shows an example of the reaction system during a regeneration step.

FIG. 3 shows reactor temperature profile at the beginning and end of a reforming step for various types of reaction zone configurations.

FIG. 4 shows temperature differential between the beginning and end of a reforming step for various types of reaction zone configurations.

FIG. 5 shows temperature differential between the beginning and end of a reforming step for various types of reaction zone configurations.

FIG. 6 shows the amount of methane conversion during reforming for various type of reaction zone configurations.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for improving control of the temperature profile in a cyclic flow reactor, such as a reverse flow reactor, during operation. The improved temperature control is achieved in part based on inclusion of regions having reduced or minimized catalyst density (such as substantially no catalyst density) with increased volumetric heat capacity within the reaction zone of the reactor. This improved control over the temperature profile is achieved while reducing or minimizing any loss of reaction capacity due to lowering the amount of catalyst in the reaction zone. Thus, a smaller amount of catalyst can be used to process a comparable amount of feed. This benefit is achieved while also preserving or possibly even improving catalyst lifetime.

In a reverse flow reactor, the catalytic material for performing the endothermic reaction is typically provided as catalyst supported on a monolith, catalyst supported on particles in a bed of particles, or in another convenient format where catalyst is supported in a way that provides increased surface area while reducing or minimizing pressure drop. Conventionally, the support materials used within the reaction zone are the same for all portions of the reaction that use the same catalyst system. This can help to ensure that the reactivity in the reaction zone is predictable based on the temperature profile. Additionally, it is conventionally believed that reducing the catalyst density in the reaction zone would have a corresponding proportional decrease in the reactivity in the reaction zone.

It has been discovered that regions of higher volumetric heat capacity and lower or minimized catalyst content (such as down to substantially no catalyst content) can be introduced into the reaction zone content while maintaining substantially similar activity across the reaction zone. By introducing one or more higher volumetric heat capacity regions into the reaction zone, temperature variations can be reduced or minimized. Additionally, the presence of the higher heat capacity regions can store a larger amount of heat, thus allowing the higher heat capacity regions to provide additional heat during the endothermic reaction step (such as a reforming step). This can allow a higher temperature to be maintained in a larger portion of the reaction zone for a given peak temperature. As a result, substantially the same activity can be achieved while using a substantially reduced amount of catalyst in the reaction zone.

Introducing regions of higher volumetric heat capacity and lower or minimized catalyst content in the reaction zone can allow for improved control over the shape of the temperature profile at locations in the reaction zone that are downstream from the peak temperature location (relative to the direction of flow during the endothermic reaction step). Such regions of higher volumetric heat capacity can reduce the temperature swing that downstream regions of catalyst are exposed to, as well as reducing or minimizing localized fluctuations. Additionally, regions of higher volumetric heat capacity and lower or minimized catalyst content can be used to so that the total loading of catalyst in a reactor can be reduced while maintaining substantially the same activity for performing an endothermic reaction.

In this discussion, reference is made to “zones” and “regions”. In this discussion, a “zone” is defined as a volume within a reactor. For example, a reactor can include a reaction zone, a mixing zone, and a recuperation zone. A “region” is defined as a volume within a zone. Depending on the configuration, it would be possible for a zone within a reactor to contain only one region. In some aspects, the reaction zone can contain at least two regions, such as a higher volumetric heat capacity region at the beginning or end of the reaction zone, with a higher catalyst density region corresponding to the rest of the reaction zone. In some other aspects, a reaction zone can include at least three regions, such as by having a higher volumetric heat capacity region that is between two regions of higher catalyst density. More generally, a reaction zone can contain any convenient number of regions of higher volumetric heat capacity and lower catalyst density, with regions of higher catalyst density located between each region of higher volumetric heat capacity and lower catalyst density, and additional end regions of higher catalyst density. It is noted that a reaction zone can potentially contain still another type of region, corresponding to a region with a reduced or minimized catalyst density while having a heat capacity similar to the high catalyst density region(s) in the reaction zone.

In some alternative aspects, at least one region having a higher volumetric heat capacity can have a different catalyst system than an adjacent region with lower heat capacity. In such aspects, the catalyst density in the higher heat capacity region can optionally be 20% or less of the catalyst density in the adjacent lower heat capacity region.

### Reactor Configuration

In this discussion, a reaction system (also referred to as a reactor system) is defined as having three zones/reactors. One zone/reactor corresponds to the reforming zone in the reactor system. This can be referred to as the reforming zone, the reaction zone, or the reforming reactor. Another zone/reactor corresponds to the recuperation zone. This can be referred to as the recuperation zone or recuperation reactor. The third zone is the mixing zone. The three zones can be ordered in a series relationship, with the mixing zone between the reforming zone and the recuperation zone. The three zones can have at least one common flow path, with the zones optionally having a common axis. The common axis can be horizontal, vertical, or any other convenient orientation. Based on the common flow path, the mixing zone can provide fluid communication between the reforming zone and the recuperation zone.

The mixing zone of the reactor system can assist with maintaining a target temperature profile during a reaction cycle. In a reverse flow reactor system, the heat needed for an endothermic reaction may be provided by creating a high-temperature heat bubble in a middle portion of the reactor system. A two-step process can then be used wherein heat is (a) added to the reactor bed(s) or monolith(s) via in-situ combustion (or more generally, oxidation of the fuel), and then (b) removed from the bed in-situ via an endothermic process, such as reforming, pyrolysis, or steam cracking. This type of configuration can provide the ability to consistently manage and confine the high temperature bubble in a reactor region(s) that can tolerate such conditions long term. A reverse flow reactor system can allow the primary endothermic and regeneration processes to be performed in a substantially continuous manner. In some aspects, the mixing zone is defined as a zone of the reactor system that does not contain reforming catalyst.

During regeneration, at least one of the fuel flow and oxidant flow is introduced into the reactor system at or near the end of the reactor system corresponding to the recuperation zone. This allows the fuel and/or oxidant flow to be heated by heat stored in the recuperation zone. In order to delay the location of combustion of fuel until the fuel is at or near the location of reforming zone, the fuel flow and oxidant flow can be introduced into the reactor via separate channels. For example, the fuel flow can be introduced into the primary volume and/or primary flow channels, while a separate set of channels can be used to introduce the oxidant flow, such as air or another O₂-containing gas. By delaying the mixing of the fuel and oxidant, the location of combustion can be controlled, so that heat is delivered primarily to the portion of the reactor system is located. This allows a high temperature zone or heat bubble to form in the middle of the reactor system. The heat bubble can correspond to a temperature that is at least about the initial temperature for the endothermic reaction. Typically, the temperature of the heat bubble can be greater than the initial temperature for the endothermic reaction, as the temperature will decrease as heat is transferred from the heat bubble in a middle portion of the reactor toward the ends of the reactor. The combustion process can take place over a long enough duration that the flow of fuel/oxidant/resulting flue gas also serves to displace a substantial portion of the heat produced by the reaction (e.g., the heat bubble), into and at least partially through the reforming zone, but preferably not all of the way through the reforming zone to avoid waste of heat. The flue gas may be exhausted through the end of the reactor corresponding to the reforming zone, but preferably most of the heat is retained within the reforming zone. The amount of heat displaced into the reforming zone during the regeneration step can also be limited or determined by the desired exposure time or space velocity that the hydrocarbon feed gas will have during the subsequent reaction step (reforming plus partial oxidation).

After the regeneration or heating step, in the next/reverse step of the cycle, reactants for the reforming reaction can be supplied or flowed through the reforming zone from the direction opposite the direction of flow during the heating step. For example, in a reforming process, methane (and/or natural gas and/or another hydrocarbon) can be supplied or flowed through the reforming zone. The methane can contact the heated surfaces in the reforming zone and/or the mixing zone, in the heat bubble region, to transfer the heat to the methane for reaction energy. This provides at least a portion of the heat for performing the reforming reaction.

Although delaying combustion of fuel during the regeneration step can allow a heat bubble to form in the middle of the reactor, using separate flow channels to deliver the oxidant to roughly the desired location for the combustion reaction means that the fuel and oxidant are not well-mixed prior to entering the reactor system. In order to reduce or minimize variations in the temperature profile across the cross-section of a reactor, mixing elements can be used to assist with mixing the fuel flow and oxidant flow.

In various aspects, the reaction system configuration can be modified to include one or more regions within the reaction zone that have increased heat capacity while also including a reduced or minimized catalyst density. These one or more regions can include monoliths, particles, and/or other material with increased volumetric heat capacity relative to the support materials used for the supporting the catalyst in the majority of the reaction zone. Depending on the aspect, the one or more regions of reduced or minimized catalyst density can be located between regions of higher catalyst density, at one or both ends of the reaction zone, or a combination thereof.

In this discussion, the catalyst density in the reaction zone is defined as the total catalyst weight divided by the total volume of the reaction zone. Similarly, the catalyst density in a region is defined as the total catalyst weight in the region divided by the volume of the region. In some aspects, the reaction zone can contain one or more regions of higher catalyst density that are separated by intervening regions of reduced or minimized catalyst density but higher volumetric heat capacity. More generally, in some aspects the reaction zone can contain any convenient number of regions where regions of higher catalyst density are separated by regions of reduced or minimized catalyst density.

In this discussion, a region of reduced or minimized catalyst density can have a catalyst density that is 20% or less of the catalyst density of a higher catalyst density region, such as any higher catalyst density regions that are adjacent to the region of reduced or minimized catalyst density. For example, a catalyst density in a region having a reduced or minimized catalyst density can be 20% or less of the catalyst density in a higher catalyst density region, or 15% or less, or 10% or less, such as down to having substantially no catalyst in the region having the reduced or minimized catalyst density.

The volumetric heat capacity of regions within the reaction zone can also be characterized. The volumetric heat capacity of a region is defined as the heat capacity per unit volume within a region based on all solids within the region. In a region of higher heat capacity and reduced or minimized catalyst density, the volumetric heat capacity of the region can be at least 1.5 times the volumetric heat capacity of a region that has higher catalyst density. Expressed as a ratio, the ratio of the volumetric heat capacity of a region having reduced or minimized catalyst density to the volumetric heat capacity of a region having higher catalyst density can be 1.5 or more, or 1.8 or more, or 2.0 or more, or 2.5 or more, such as up to 5.0 or possibly still higher.

Some examples of materials that have higher heat capacity are high density ferritic alloys of aluminum, or alloys of iron, nickel, and aluminum. Such alloys can have roughly twice the density of alpha-alumina while having similar heat capacity on a per gram basis. As a result, a monolith made of such a high density alloy can have a volumetric heat capacity that is roughly twice the heat capacity of an alumina monolith. Ferritic alloys of alumina are not conventionally used as catalyst supports, but terrific alloys of alumina are stable at temperatures of up to 1400° C., and are substantially non-reactive in the presence of the gas flows present for reactions such as hydrocarbon reforming.

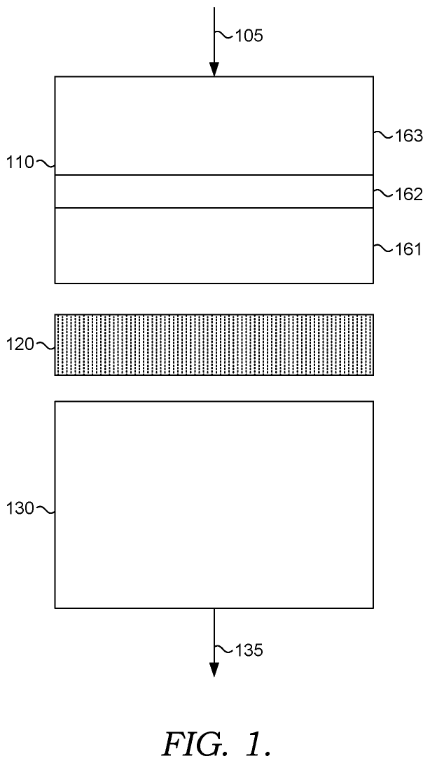

FIG. 1 shows an example of a reverse flow reactor including a reaction zone 110, a mixing zone 120, and a recuperation zone 130. In FIG. 1, the portion of reaction zone 110 includes three regions, corresponding to region 161, region 162, and region 163. Regions 161 and 163 correspond to regions with higher catalyst density. Region 162 is between regions 161 and 163. Region 162 has a catalyst density that is less than 20% of the catalyst density of either region 161 or region 163. Additionally, the volumetric heat capacity in region 162 is at least 1.5 times the volumetric heat capacity in either region 161 or region 163.

In a configuration such as the configuration shown in FIG. 1, the presence of high volumetric heat capacity, low catalyst density regions within the reaction zone can modify the temperature profile that is formed during a reaction cycle. The modifications to a reaction cycle based on the presence of high heat capacity, low catalyst density regions can be illustrated with reference to FIG. 1 and with reference to a reaction cycle with hydrocarbon reforming as the endothermic reaction.

During the reforming step of a reaction cycle, the surfaces in the reaction zone are typically cooled as the reforming reaction consumes heat from the environment. However, in the configuration shown in FIG. 1, region 162 includes a reduced or minimized amount of catalyst. Thus, as the reaction proceeds, regions 161 and 163 will be cooled more rapidly than region 162. Heat from region 162 can then flow into region 161 and/or 163 to mitigate the drop in temperature. Additionally or alternately, to the degree that temperatures are higher in region 162, this can heat the reforming gas flow(s) to assist with maintaining higher temperatures in downstream regions in the reaction zone. The additional heating provided by the high heat capacity, lower catalyst density region 162 can allow the catalyst in region 161 and/or 163 to stay at desirable reaction temperatures for a longer period of time during a reforming step.

After the reforming step is finished, a regeneration step can be performed to increase the temperature in the reactor in preparation for the next reforming step. During regeneration, the temperature increase in region 162 is reduced relative to regions 161 and 163 by the higher volumetric heat capacity in region 162. To the degree that there are temperature differentials within the reaction zone, the higher heat capacity in region 162 can mitigate the formation of localized hot spots in the vicinity of region 162.

To illustrate operation, FIG. 1 is further described in conjunction with performing a reforming reaction cycle. In FIG. 1, a feed flow 105 containing reformable hydrocarbons (such as methane) is passed into reforming zone 110, where the feed flow is exposed to reforming conditions to form reforming product 135. This reduces the temperature of regions 161 and 163 of reforming zone 110 as the reforming reaction occurs, due to the endothermic nature of the reaction. The cooling in region 162 is reduced, however, relative to regions 161 and 163, due to the reduced or minimized amount of catalyst density.

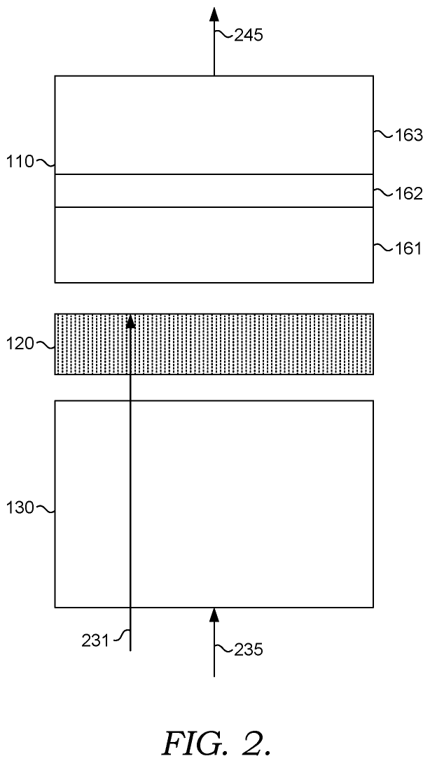

FIG. 2 shows a reaction system similar to FIG. 1, but during the regeneration step. In the example shown in FIG. 2, fuel flow 235 is introduced into recuperation zone 130. An oxidant flow 231 (such as air or another O₂-containing gas) is passed into the mixing zone 120 using separate channels from the flow path for fuel flow 235. Thus, in the example shown in FIG. 2, oxidant flow 231 is not in fluid communication with the flow path for fuel flow 235 until the oxidant flow and fuel flow reach the mixing zone. At least one of fuel flow 235 and oxidant flow 231 is heated by the recuperation zone prior to entering mixing zone 120. The mixing of fuel flow 235 and oxidant flow 231 causes partial oxidation and/or combustion of the fuel flow 235, resulting in generation of heat and a flue gas. The heat is carried through reforming zone 110 by the resulting flue gas. This transfers heat to the internal surfaces of reforming zone 110, thus providing the heat needed for the subsequent reforming step. The flue gas exits 245 from the reforming zone end of the reactor system. During the regeneration step, region 162 can mitigate local temperature fluctuations that might cause hot spots.

It is noted that the oxidant flow for the regeneration step (such as oxidant flow 231) can have any convenient content of O₂. In some aspects, using a higher purity O₂ content flow as the oxidant flow for regeneration can facilitate performing carbon capture on the flue gas from regeneration. In such aspects, an air separation unit can be used to generate at least a portion of the oxidant flow for regeneration. Optionally, in such aspects, CO₂ and/or H₂O can be added to the oxidant flow to improve the heat transfer properties of the oxidant flow. In other aspects, air can be used as the oxidant flow, to avoid the need for performing a separation to form the oxidant flow. In still other aspects, a mixture of air and higher purity O₂ can be used. In various aspects, the O₂ content of the oxidant stream for the regeneration step can range from 20 vol % to 100 vol %, or 20 vol % to 80 vol %, or 20 vol % to 60 vol %, or 20 vol % to 40 vol %, or 40 vol % to 100 vol %, or 60 vol % to 100 vol %, or 80 vol % to 100 vol %. In aspects where air is not used and/or where O₂ from an air separation unit is used as part of the oxidant flow for regeneration, O₂ can be diluted with CO₂ and/or H₂O to improve the heat transport properties of the gas flow. As an example, an O₂-containing stream can include a combined amount of CO₂ and O₂ that corresponds to 50 vol % or more of the stream, such as up to the stream comprising substantially only CO₂ and 02. In such an aspect, the N₂ content of the stream can be 25 vol % or less, such as down to having substantially no N₂ content.

Both the reforming zone 110 and the recuperation zone 130 can contain regenerative monoliths and/or other regenerative structures. Regenerative monoliths or other regenerative structures, as used herein, comprise materials that are effective in storing and transferring heat as well as being effective for carrying out a chemical reaction. The regenerative monoliths and/or other structures can correspond to any convenient type of material that is suitable for storing heat, transferring heat, and catalyzing a reaction. Examples of structures can include bedding or packing material, ceramic beads or spheres, ceramic honeycomb materials, ceramic tubes, extruded monoliths, and the like, provided they are competent to maintain integrity, functionality, and withstand long term exposure to temperatures in excess of 1200° C., or in excess of 1400° C., or in excess of 1600° C., which can allow for some operating margin. In various aspects, one or more regions of the reaction zone can include structures that have a higher heat capacity.

In some aspects, the recuperator can be comprised of one or more extruded honeycomb monoliths, as described above. Each monolith may provide flow channel(s) (e.g., flow paths) for one of the first or second reactants. Each channel preferably includes a plurality of conduits. Alternatively, a monolith may comprise one or more channels for each reactant with one or more channels or groups of conduits dedicated to flowing one or more streams of a reactant, while the remaining portion of conduits flow one or more streams of the other reactant. It is recognized that at the interface between channels, a number of conduits may convey a mixture of first and second reactant, but this number of conduits is proportionately small.

Alternative embodiments may use reactor media other than monoliths, such as whereby the channel conduits/flow paths may include a more tortuous pathways (e.g. convoluted, complex, winding and/or twisted but not linear or tubular), including but not limited to labyrinthine, variegated flow paths, conduits, tubes, slots, and/or a pore structure having channels through a portion(s) of the reactor and may include barrier portion, such as along an outer surface of a segment or within sub-segments, having substantially no effective permeability to gases, and/or other means suitable for preventing cross flow between the reactant gases and maintaining the first and second reactant gases substantially separated from each other while axially transiting the recuperation zone. Such other types of reactor media can be suitable, so long as at least a portion of such media can be formed by sintering a ceramic catalytic composition as described herein, followed by exposing such media to reducing conditions to activate the catalyst. For such embodiments, the complex flow path may create a lengthened effective flow path, increased surface area, and improved heat transfer. Such design may be preferred for reactor embodiments having a relatively short axial length through the reactor. Axially longer reactor lengths may experience increased pressure drops through the reactor. However for such embodiments, the porous and/or permeable media may include, for example, at least one of a packed bed, an arrangement of tiles, a permeable solid media, a substantially honeycomb-type structure, a fibrous arrangement, and a mesh-type lattice structure.

In some aspects, the regenerative bed(s) and/or monolith(s) of the recuperation zone can comprise channels having a gas or fluid barrier that isolates the first reactant channels (e.g., containing fuel) from the second reactant channels (e.g., containing oxidant). Thereby, both of the at least two reactant gases that transit the channel means may fully transit the regenerative bed(s), to quench the regenerative bed, absorb heat into the reactant gases, before combining to react with each other in the mixing zone.

By keeping the fuel and oxidant substantially separated, the location of the heat release that occurs due to exothermic reaction can be controlled. In some aspects “substantially separated” can be defined to mean that at least 50 percent, or at least 75 percent, or at least 90 percent of the reactant having the smallest or limiting stoichiometrically reactable amount of reactant, as between the first and second reactant streams, has not become consumed by reaction by the point at which these gases have completed their axial transit of the recuperator 27. In this manner, the majority of the first reactant 30 can be kept isolated from the majority of the second reactant 32, and the majority of the heat release from the reaction of combining reactants 30 and 32 can take place after the reactants begin exiting the recuperator 27. The reactants can be gases, but optionally some reactants may comprise a liquid, mixture, or vapor phase.

The percent reaction for these regeneration streams is meant the percent of reaction that is possible based on the stoichiometry of the overall feed. For example, if gas 30 comprised 100 volumes of air (80 volumes N₂ and 20 Volumes O₂), and gas 32 comprised 10 volumes of hydrogen, then the maximum stoichiometric reaction would be the combustion of 10 volumes of hydrogen (H₂) with 5 volumes of oxygen (O₂) to make 10 volumes of H₂O. In this case, if 10 volumes of hydrogen were actually combusted in the recuperator zone (27), this would represent 100% reaction of the regeneration stream. This is despite the presence of residual un-reacted oxygen, because in this example the un-reacted oxygen was present in amounts above the stoichiometric requirement. Thus, in this example the hydrogen is the stoichiometrically limiting component. Using this definition, less than 50% reaction, or less than 25% reaction, or less than 10% reaction of the regeneration streams can occur during the axial transit of the recuperation zone.

In various aspects, channels can comprise ceramic (including zirconia), alumina, or other refractory material capable of withstanding temperatures exceeding 1200° C., or 1400° C., or 1600° C. Additionally or alternately, channels can have a wetted area between 50 ft⁻¹ and 3000 ft⁻¹, or between 100 ft⁻¹ and 2500 ft⁻¹, or between 200 ft⁻¹ and 2000 ft⁻¹.

### Process Example—Reverse Flow Reforming and Regeneration

In various aspects, the conversion of hydrocarbons during the reaction step of the cycle can be improved by performing a combination of reforming and partial oxidation.

The reforming reaction performed within the reactor can correspond reforming of methane and/or other hydrocarbons using steam reforming, in the presence of H₂O; using dry reforming, in the presence of CO₂, or using “bi” reforming in the presence of both H₂O and CO₂. Examples of stoichiometry for steam, dry, and “bi” reforming of methane are shown in equations (1)-(3).

Dry Reforming: CH₄+CO₂=2CO+2H₂ (1)

Steam Reforming: CH₄+H₂O═CO+3H₂ (2)

Bi Reforming: 3CH₄+2H₂O+CO₂=4CO+8H₂. (3)

As shown in equations (1)-(3), dry reforming can produce lower ratios of H₂ to CO than steam reforming. Reforming reactions performed with only steam can generally produce a ratio of H₂ to CO of around 3, such as 2.5 to 3.5. By contrast, reforming reactions performed in the presence of CO₂ can generate much lower ratios, possibly approaching a ratio of H₂ to CO of roughly 1.0 or even lower. By using a combination of CO₂ and H₂O during reforming, the reforming reaction can potentially be controlled to generate a wide variety of H₂ to CO ratios in a resulting syngas.

It is noted that the ratio of H₂ to CO in a synthesis gas can also be dependent on the water gas shift equilibrium. Although the above stoichiometry shows ratios of roughly 1 or roughly 3 for dry reforming and steam reforming, respectively, the equilibrium amounts of H₂ and CO in a synthesis gas can be different from the reaction stoichiometry. The equilibrium amounts can be determined based on the water gas shift equilibrium, which relates the concentrations of H₂, CO, CO₂ and H₂O based on the reaction

H₂O+CO<=>H₂+CO₂ (4)

Most reforming catalysts, such as rhodium and/or nickel, can also serve as water gas shift catalysts. Thus, if reaction environment for producing H₂ and CO also includes H₂O and/or CO₂, the initial stoichiometry from the reforming reaction may be altered based on the water gas shift equilibrium. This equilibrium is also temperature dependent, with higher temperatures favoring production of CO and H₂O. It is noted that higher temperatures can also improve the rate for reaching equilibrium. As a result, the ability to perform a reforming reaction at elevated temperatures can potentially provide several benefits. For example, instead of performing steam reforming in an environment with excess H₂O, CO₂ can be added to the reaction environment. This can allow for both a reduction in the ratio of H₂ to CO produced based on the dry reforming stoichiometry as well as a reduction in the ratio of H₂ to CO produced based on the water gas shift equilibrium. Alternatively, if a higher H₂ to CO ratio is desired, CO₂ can be removed from the environment, and the ratio of H₂O to CH₄ (or other hydrocarbons) can be controlled to produce a desirable type of synthesis gas. This can potentially allow for generation of a synthesis gas having a H₂ to CO ratio of 0.1 to 15, or 0.1 to 3.0, or 0.5 to 5.0, or 1.0 to 10, by selecting appropriate amounts of feed components.

The reforming reactions shown in equations (1)-(3) are endothermic reactions. One of the challenges in commercial scale reforming can be providing the heat for performing the reforming reaction in an efficient manner while reducing or minimizing introduction of additional components into the desired synthesis gas product. Cyclic reaction systems, such as reverse flow reactor systems, can provide heat in a desirable manner by having a cycle including a reforming step and a regeneration step. During the regeneration step, combustion can be performed within a selected area of the reactor. A gas flow during regeneration can assist with transferring this heat from the combustion zone toward additional portions of the reforming zone in the reactor. The reforming step within the cycle can be a separate step, so that incorporation of products from combustion into the reactants and/or products from reforming can be reduced or minimized. The reforming step can consume heat, which can reduce the temperature of the reforming zone. As the products from reforming pass through the reactor, the reforming products can pass through a second zone that lacks a reforming or water gas shift catalyst. This can allow the reaction products to cool prior to exiting the reactor. The heat transferred from the reforming products to the reactor can then be used to increase the temperature of the reactants for the next combustion or regeneration step.

One common source for methane is natural gas. In some applications, natural gas, including associated hydrocarbon and impurity gases, may be used as a feed for the reforming reaction. The supplied natural gas also may be sweetened and/or dehydrated natural gas. Natural gas commonly includes various concentrations of associated gases, such as ethane and other alkanes, preferably in lesser concentrations than methane. The supplied natural gas may include impurities, such as H₂S and nitrogen. More generally, the hydrocarbon feed for reforming can include any convenient combination of methane and/or other hydrocarbons. Optionally, the reforming feed may also include some hydrocarbonaceous compounds, such as alcohols or mercaptans, which are similar to hydrocarbons but include one or more heteroatoms different from carbon and hydrogen. In some aspects, an additional component present in the feed can correspond to impurities such as sulfur that can adsorb to the catalytic monolith during a reducing cycle (such as a reforming cycle). Such impurities can be oxidized in a subsequent cycle to form sulfur oxides, which can then be reduced to release additional sulfur-containing components (or other impurity-containing components) into the reaction environment.

In some aspects, the feed for reforming can include, relative to a total weight of hydrocarbons in the feed for reforming, 5 wt % or more of C₂₊ compounds, such as ethane or propane, or 10 wt % or more, or 15 wt % or more, or 20 wt % or more, such as up to 50 wt % or possibly still higher. It is noted that nitrogen and/or other gases that are non-reactive in a combustion environment, such as H₂O and CO₂, may also be present in the feed for reforming. In aspects where the reformer corresponds to an on-board reforming environment, such non-reactive products can optionally be introduced into the feed, for example, based on recycle of an exhaust gas into the reformer. Additionally or alternately, the feed for reforming can include 40 wt % or more methane, or 60 wt % or more, or 80 wt % or more, or 95 wt % or more, such as having a feed that is substantially composed of methane (98 wt % or more). In aspects where the reforming corresponds to steam reforming, a molar ratio of steam molecules to carbon atoms in the feed can be 0.3 to 4.0. It is noted that methane has 1 carbon atom per molecule while ethane has 2 carbon atoms per molecule. In aspects where the reforming corresponds to dry reforming, a molar ratio of CO₂ molecules to carbon atoms in the feed can be 0.05 to 3.0.

Within the reforming zone of a reverse flow reactor, the temperature can vary across the zone due to the nature of how heat is added to the reactor and/or due to the kinetics of the reforming reaction. The highest temperature portion of the zone can typically be found near a middle portion of the reactor. This middle portion can be referred to as a mixing zone where combustion is initiated during regeneration. At least a portion of the mixing zone can correspond to part of the reforming zone if a monolith with reforming catalyst extends into the mixing zone. As a result, the location where combustion is started during regeneration can typically be near to the end of the reforming zone within the reactor. Moving from the center of the reactor to the ends of the reactor, the temperature can decrease. As a result, the temperature at the beginning of the reforming zone (at the end of the reactor) can be cooler than the temperature at the end of the reforming zone (in the middle portion of the reactor).

As the reforming reaction occurs, the temperature within the reforming zone can be reduced. The rate of reduction in temperature can be related to the kinetic factors of the amount of available hydrocarbons for reforming and/or the temperature at a given location within the reforming zone. As the reforming feed moves through the reforming zone, the reactants in the feed can be consumed, which can reduce the amount of reforming that occurs at downstream locations. However, the increase in the temperature of the reforming zone as the reactants move across the reforming zone can lead to an increased reaction rate.

At roughly 500° C., the reaction rate for reforming can be sufficiently reduced that little or no additional reforming will occur. As a result, in some aspects as the reforming reaction progresses, the beginning portion of the reforming zone can cool sufficiently to effectively stop the reforming reaction within a portion of the reforming zone. This can move the location within the reactor where reforming begins to a location that is further downstream relative to the beginning of the reforming zone. When a sufficient portion of the reforming zone has a temperature below 500° C., or below 600° C., the reforming step within the reaction cycle can be stopped to allow for regeneration. Alternatively, based on the amount of heat introduced into the reactor during regeneration, the reforming portion of the reaction cycle can be stopped based on an amount of reaction time, so that the amount of heat consumed during reforming (plus heat lost to the environment) is roughly in balance with the amount of heat added during regeneration. After the reforming process is stopped, any remaining synthesis gas product still in the reactor can optionally be recovered prior to starting the regeneration step of the reaction cycle.

The regeneration process can then be initiated. During regeneration, a fuel such as methane, natural gas, or Hz, and oxygen can be introduced into the reactor and combusted. The location where the fuel and oxidant are allowed to mix can be controlled in any convenient manner, such as by introducing the fuel and oxidant via separate channels. By delaying combustion during regeneration until the reactants reach a central portion of the reactor, the non-reforming end of the reactor can be maintained at a cooler temperature. This can also result in a temperature peak in a middle portion of the reactor. Optionally, at least one temperature peak can occur within the reforming zone. Optionally, such a temperature peak can occur within the heat sink portion of the reforming zone. During a regeneration cycle, the temperature within the reforming zone can be increased sufficiently to allow for the reforming during the reforming portion of the cycle. This can result in a peak temperature within the reforming zone of 1100° C. or more, or 1200° C. or more, or 1300° C. or more, or potentially a still higher temperature.

In some aspects, the conditions for regeneration can be selected so that the peak temperature that a reforming catalyst is exposed to is lower than the peak temperature in the reforming zone. For example, the peak temperature that reforming catalyst is exposed to can be lower than the peak temperature in the reforming zone by 50° C. or more, or 100° C. or more, such as up to 250° C. or possibly still more. In some aspects, the peak temperature that reforming catalyst is exposed to can be 1000° C. or less, or 950° C. or less, or 900° C. or less, or 850° C. or less, such as down to 750° C. or possibly still lower. In some aspects, the peak temperature that reforming catalyst is exposed to can be between 600° C. to 1200° C., or 850° C. to 1000° C., or 900° C. to 1000° C., or 800° C. to 950° C., or 850° C. to 950° C., or 800° C. to 900° C.

The relative length of time and reactant flow rates for the reforming and regeneration portions of the process cycle can be selected to balance the heat provided during regeneration with the heat consumed during reforming. For example, one option can be to select a reforming step that has a similar length to the regeneration step. Based on the flow rate of hydrocarbons, H₂O, and/or CO₂ during the reforming step, an endothermic heat demand for the reforming reaction can be determined. This heat demand can then be used to calculate a flow rate for combustion reactants during the regeneration step. Of course, in other aspects the balance of heat between reforming and regeneration can be determined in other manners, such as by determining desired flow rates for the reactants and then selecting cycle lengths so that the heat provided by regeneration balances with the heat consumed during reforming.

In addition to providing heat, the reactor regeneration step during a reaction cycle can also allow for coke removal from the catalyst within the reforming zone. In various aspects, one or more types of catalyst regeneration can potentially occur during the regeneration step. One type of catalyst regeneration can correspond to removal of coke from the catalyst. During reforming, a portion of the hydrocarbons introduced into the reforming zone can form coke instead of forming CO or CO₂. This coke can potentially block access to the catalytic sites (such as metal sites) of the catalyst. In some aspects, the rate of formation can be increased in portions of the reforming zone that are exposed to higher temperatures, such as portions of the reforming zone that are exposed to temperatures of 800° C. or more, or 900° C. or more, or 1000° C. or more. During a regeneration step, oxygen can be present as the temperature of the reforming zone is increased. At the temperatures achieved during regeneration, at least a portion of the coke generated during reforming can be removed as CO or CO₂.

Due to the variation in temperature across the reactor, several options can be used for characterizing the temperature within the reactor and/or within the reforming zone of the reactor. One option for characterizing the temperature can be based on an average bed or average monolith temperature within the reforming zone. In practical settings, determining a temperature within a reactor requires the presence of a measurement device, such as a thermocouple. Rather than attempting to measure temperatures within the reforming zone, an average (bed or monolith) temperature within the reforming zone can be defined based on an average of the temperature at the beginning of the reforming zone and a temperature at the end of the reforming zone. Another option can be to characterize the peak temperature within the reforming zone after a regeneration step in the reaction cycle. Generally, the peak temperature can occur at or near the end of the reforming zone, and may be dependent on the location where combustion is initiated in the reactor. Still another option can be to characterize the difference in temperature at a given location within the reaction zone at different times within a reaction cycle. For example, a temperature difference can be determined between the temperature at the end of the regeneration step and the temperature at the end of the reforming step. Such a temperature difference can be characterized at the location of peak temperature within the reactor, at the entrance to the reforming zone, at the exit from the reforming zone, or at any other convenient location.

In various aspects, the reaction conditions for reforming hydrocarbons can include one or more of an average reforming zone temperature ranging from 400° C. to 1200° (or more); a peak temperature within the reforming zone of 800° C. to 1500° C.; a temperature difference at the location of peak temperature between the end of a regeneration step and the end of the subsequent reforming step of 25° C. or more, or 50° C. or more, or 100° C. or more, or 200° C. or more, such as up to 800° C. or possibly still higher; a temperature difference at the entrance to the reforming zone between the end of a regeneration step and the end of the subsequent reforming step of 25° C. or more, or 50° C. or more, or 100° C. or more, or 200° C. or more, such as up to 800° C. or possibly still higher; and/or a temperature difference at the exit from the reforming zone between the end of a regeneration step and the end of the subsequent reforming step of 25° C. or more, or 50° C. or more, or 100° C. or more, or 200° C. or more, such as up to 800° C. or possibly still higher. For example, the temperature difference between the end of the regeneration step and the end of the reforming step at the location of peak temperature and/or at the entrance to the reforming zone can be 80° C. to 220° C., or 80° C. to 160° C., or 100° C. to 220° C., or 100° C. to 160° C., or 120° C. to 220° C., or 120° C. to 160° C.

With regard to the average reforming zone temperature, in various aspects the average temperature for the reforming zone can be 500° C. to 1500° C., or 400° C. to 1200° C., or 800° C. to 1200° C., or 400° C. to 900° C., or 600° C. to 1100° C., or 500° C. to 1000° C. Additionally or alternately, with regard to the peak temperature for the reforming zone (likely corresponding to a location in the reforming zone close to the location for combustion of regeneration reactants), the peak temperature can be 800° C. to 1500° C., or 1000° C. to 1400° C., or 1200° C. to 1500° C., or 1200° C. to 1400° C.

Additionally or alternately, the reaction conditions for reforming hydrocarbons can include a pressure of 0 psig to 1500 psig (10.3 MPa), or 0 psig to 1000 psig (6.9 MPa), or 0 psig to 550 psig (3.8 MPa); and a gas hourly space velocity of reforming reactants of 1000 hr⁻¹ to 50,000 hr⁻¹. The space velocity corresponds to the volume of reactants relative to the volume of monolith per unit time. The volume of the monolith is defined as the volume of the monolith as if it was a solid cylinder.

It is noted that the partial oxidation portion of the reaction occurs primarily outside of the reforming zone, in the mixing zone and/or the recuperation zone of the reactor system. In various aspects, the peak temperature in the recuperation zone may occur at or near the end of the reforming step. This is in contrast to the reforming zone, where the peak temperature will occur at or near the end of the regeneration step. For the recuperation zone, the peak temperature can be 700° C. to 1600° C., or 700° C. to 1400° C., or 700° C. to 1200° C., or 850° C. to 1600° C., or 1000° C. to 1600° C., or 1000° C. to 1400° C., or 1200° C. to 1400° C., or 1200° C. to 1600° C.

### Monolith Structure(s) for Supporting Catalyst System

One of the purposes of using a monolith or another supporting structure within a reforming environment is to increase the available surface area for holding a deposited catalyst/catalyst system. To achieve this, some monoliths correspond to a structure with a large plurality of cells or channels that allow gas flow through the monolith. Because each individual cell provides surface area for deposition of catalyst, including a large number of cells or channels per unit area can substantially increase the available surface area for catalyst. Such monoliths can generally be referred to as honeycomb monoliths. It is noted that the terms “cell” and “channel” can be used interchangeably to refer to the passages through a monolith.

In various aspects, a monolith or other structure for providing a surface for the reforming catalyst system may be prepared by manufacturing techniques such as but not limited to conventional ceramic powder manufacturing and processing techniques, e.g., mixing, milling, degassing, kneading, pressing, extruding, casting, drying, calcining, and sintering. The starting materials can correspond to a suitable ceramic powder such as synthetic alumina powder and naturally occurring minerals (e.g. bauxite, bentonite, talc) and an organic binder powder in a suitable volume ratio. Certain process steps may be controlled or adjusted to obtain the desired grain size and porosity range and performance properties, such as by inclusion of various manufacturing, property adjusting, and processing additives and agents as are generally known in the art. For example, the two or more types of oxide powders may be mixed in the presence of an organic binder and one or more appropriate solvents or water for a time sufficient to substantially disperse the powders in each other. As another example, precursors of the oxides present in a monolith may be dissolved in water at a desired ratio, spray dried, and calcined to make a mixed powder. Such precursors include (but are not limited to) chlorides, sulfates, nitrates, and mixtures thereof. The calcined powder can be further mixed in the presence of an organic binder and appropriate solvent(s) to make a mixed “dough”. Then, the mixed “dough” of materials can be placed in a kneader to mix all the ingredient and to enhance plasticity of the mixed “dough”. The number of kneading times and kneading speed can be adjusted. The kneaded “dough” can be placed in a die or form, extruded, dried or otherwise formed into a desired shape. As a non-limiting example, a screw type extruder can be used, and rotation speed of top and bottom screw can be controlled to form a honeycomb shape. As it produces, a wire cutter attached in the screw type extruder operates to make a desired height of the honeycomb monoliths. The resulting extruded body can then be dried to form a “green body”. As a non-limiting example, hot air dryer can be used to slowly remove the residual solvent or water in the extruded body. Yet another non-limiting example, a standalone microwave oven or even a continuous microwave drying oven can be used to form a “green body”. Drying in a microwave oven is advantageous since it shortens total drying time and minimizes potential cracking associated with a rather rapid drying process. The resulting “green body” can then be sintered at temperatures in the range of about 1500° C.-1700° C. for at least ten minutes, such as from 10 minutes to 48 hours, or possibly from 10 minutes up to 10 days or still longer. Either a batch furnace or a continuous tunnel kiln can be used to sinter the “green body”. During sintering the “green body” shrinks as it densities and consolidates. The sintering shrinkage is typically about 20˜30%.

The sintering operation may be performed in an oxidizing atmosphere, reducing atmosphere, or inert atmosphere, and at ambient pressure or under vacuum. For example, the oxidizing atmosphere could be air or oxygen, the inert atmosphere could be argon, and a reducing atmosphere could be hydrogen, CO/CO₂ or H₂/H₂O mixtures. Thereafter, the sintered body is allowed to cool, typically to ambient conditions. The cooling rate may also be controlled to provide a desired set of grain and pore structures and performance properties in the particular component.

It is noted that after the sintering operation, any alumina present in the monolith will be substantially converted to α-alumina. The “alpha” phase of alumina is thermodynamically favored at high temperatures, and the temperatures during sintering are sufficient convert substantially all of any other phases of alumina into the “alpha” phase. This is beneficial from a stability standpoint, as converting the alumina in the monolith to α-alumina means that phase transitions are not occurring during exposure of the monolith to the cyclic reforming conditions, where the presence of alternative phases of alumina might facilitate crack formation and/or propagation.

In some aspects, the monolith material (PQ) can further include an intermediate bond layer. The intermediate bond layer can be applied on monolith surfaces prior to forming a washcoat of active materials (e.g., catalyst). In such aspects, the intermediate bond layer provides a better adherence to the washcoated active material. In such aspects, the intermediate bond layer is a metal oxide, (M)ₓO_{y}, wherein (M) is at least one metal selected from the group consisting of Al, Si, Mg, Ca, Sr, Ba, K, Na, Ti, Zr, Hf, V, Nb, Ta, Cr, Mo, W, Mn, Fe, Ni, Co, Y, La, Ce, and mixtures thereof. Aluminum oxide (a.k.a. alumina), Al₂O₃, is a preferred metal oxide for the bond layer. As an example of how to form an intermediate bond layer, the selected metal oxide, (M)ₓO_{y}, can be dispersed in a solution to form a slurry. The slurry can then be washcoated on the monolith. The monolith washcoated with the selected metal oxide, (M)ₓO_{y}, is dried and sintered at temperatures in the range of 1100° C.-1600° C. to make the intermediate bonding layer.

It has been discovered that limiting the maximum porosity in the final sintered body tends to effectively, if not actually, limit interconnectivity of the pore spaces with other pore spaces to an extent that increases or maximizes volumetric heat capacity of the sintered body. The porosity ranges for a monolith or other structure can depend upon the desired final component performance properties, but are within a range defined by one or more of the minimum porosity values and one or more of the maximum porosity values, or any set of values not expressly enumerated between the minimums and maximums. Examples of suitable porosity values are 0 vol % to 20 vol % porosity, or 0 vol % to 15 vol %, or 0 vol % to 10 vol %, or 0 vol % to 5 vol %.

The sintered monolith and/or other formed ceramic structure can have any convenient shape suitable for use as a surface for receiving a catalyst or catalyst system. An example of a monolith can be an extruded honeycomb monolith. Honeycomb monoliths can be extruded structures that comprise many (e.g., a plurality, meaning more than one) small gas flow passages or conduits, arranged in parallel fashion with thin walls in between. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other. Monoliths can be attractive as reactor internal structures because they provide high heat transfer capacity with minimum pressure drop.

In some aspects, density, measured by an Archimedes method well-known to the skilled in the art, can be 3.40 gram/cc or more, or 3.50 gram/cc or more, such as up to 3.95 gram/cc which is theoretical density of alumina, or possibly still higher if it contains heavier metal oxides. In some aspects, porosity can be nearly completely closed within the honeycomb monolith walls with the porosity being 10% or less, or 8.0% or less, such as down to 1.0% or possibly still lower.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter. Reactor media components, such as the monoliths or alternative bed media, can provide for channels that include a packing with an average wetted surface area per unit volume that ranges from 50 ft⁻¹ to 3000 ft⁻¹ (˜0.16 km⁻¹ to ˜10 km⁻¹), or from 100 ft⁻¹ to 2500 ft⁻¹ (˜0.32 km⁻¹ to ˜8.2 km⁻¹), or from 200 ft⁻¹ to 2000 ft⁻¹ (˜0.65 km⁻¹ to ˜6.5 km⁻¹), based upon the volume of the first reactor that is used to convey a reactant. These relatively high surface area per unit volume values can aid in achieving a relatively quick change in the temperature through the reactor.

Reactor media components can also provide for channels that include a packing that includes a high volumetric heat transfer coefficient (e.g., 0.02 cal/cm³s° C. or more, or 0.05 cal/cm³s° C. or more, or 0.10 cal/cal/cm³s° C. or more); that have low resistance to flow (low pressure drop); that have an operating temperature range consistent with the highest temperatures encountered during regeneration; that have high resistance to thermal shock; and/or that have high bulk heat capacity (e.g., 0.10 cal/cm³s° C. or more, or 0.20 cal/cm³s° C. or more). As with the high surface area values, these relatively high volumetric heat transfer coefficient values and/or other properties can aid in achieving a relatively quick change in the temperature through the reactor, such as generally illustrated by the relatively steep slopes in the exemplary temperature gradient profile graphs, such as in FIGS. 2(a) and 2(b) of FIG. 2. The cited values are averages based upon the volume of reactor used for conveyance of a reactant.

In various aspects, adequate heat transfer rate can be characterized by a heat transfer parameter, ΔTHT, below 500° C., or below 100° C., or below 50° C. The parameter ΔTHT, as used herein, is the ratio of the bed-average volumetric heat transfer rate that is needed for recuperation, to the volumetric heat transfer coefficient of the bed, hv. The volumetric heat transfer rate (e.g. cal/cm³ sec) that is sufficient for recuperation can be calculated as the product of the gas flow rate (e.g. g/sec) with the gas heat capacity (e.g. cal/g° C.) and desired end-to-end temperature change (excluding any reaction, e.g. ° C.), and then this quantity can be divided by the volume (e.g. cm³) of the reactor (or portion of a reactor) traversed by the gas. The volumetric heat transfer coefficient of the bed, hv, can typically be calculated as the product of an area-based coefficient (e.g. cal/cm²s° C.) and a specific surface area for heat transfer (av, e.g. cm²/cm³), often referred to as the wetted area of the packing.

### Catalysts and Catalyst Systems

In various aspects, catalyst systems are provided for reforming of hydrocarbons, along with methods for using such catalyst systems. The catalyst systems can be deposited or otherwise coated on a surface or structure, such as a monolith, to achieve improved activity and/or structural stability. In this discussion, a catalyst system is defined to include at least one catalyst corresponding to one or more catalytic metals, optionally in the form of a metal oxide, and at least one metal oxide support layer. In some aspects, the catalyst and metal oxide support layer can be coated on the monolith at the same time, such as in the form of a washcoat layer on the support. In such aspects, the catalyst can be intermixed with the metal oxide support layer. Alternatively, the catalyst and metal oxide support layer can be deposited sequentially so that the support layer is deposited first, followed by the catalyst. In some aspects, the metal oxide support layer can correspond to a thermally stable metal oxide support layer, such as a metal oxide support layer that is thermally phase stable at temperatures of 800° C. to 1600° C. Optionally, an intermediate bonding layer can be applied to at least a portion of the monolith or other structure prior to depositing the catalyst system. The catalyst systems can be beneficial for use in cyclical reaction environments, such as reverse flow reactors or other types of reactors that are operated using flows in opposing directions and different times within a reaction cycle. The reaction conditions in cyclical reaction environments can also undergo swings in temperature and/or pressure during a reaction cycle. In still other aspects, a catalyst can be deposited without using a corresponding metal oxide support layer.

In some aspects, the catalyst system can correspond to one or more catalysts in a single zone. In other aspects, the catalyst system can correspond to a plurality of catalyst zones. Optionally in such aspects, at least one catalyst zone can include a catalyst that is different from the catalyst(s) in a second catalyst zone.

In some aspects, the catalyst system can include a thermally stable metal oxide support layer. A thermally stable metal oxide support layer corresponds to a metal oxide that is thermally phase stable with regard to structural phase changes at temperatures between 800° C. to 1600° C. In some aspects, such a thermally stable metal oxide support layer can be formed by coating a surface (such using a washcoat) with a metal oxide powder that has a surface area of 20 m²/g or less. For example, the metal oxide powder used for forming a thermally stable metal oxide coating can have a surface area of 0.5 m²/g to 20 m²/g, or 1.0 m²/g to 20 m²/g, or 5.0 m²/g to 20 m²/g. High temperature reforming refers to reforming that takes place at a reforming temperature of 1000° C. or more, or 1100° C. or more, or 1200° C. or more, such as up to 1500° C. or possibly still higher. In various aspects, a catalyst can be annealed at a temperature of 1000° C. or more, or 1100° C. or more, or 1200° C. or more, or 1300° C. or more, such as up to 1600° C. or possibly still higher. This temperature can be substantially similar to or greater than the peak temperature the catalyst is exposed to during a reforming process cycle. An annealing temperature that is substantially similar to a peak temperature can correspond to an annealing temperature that differs from the peak temperature by 0° C. to 50° C.

As an example of a thermally stable metal oxide support layer, alumina has a variety of phases, including α-Al₂O₃, γ-Al₂O₃, and θ-Al₂O₃. A metal powder of α-Al₂O₃ can typically have a surface area of 20 m²/g or less. By contrast, the γ-Al₂O₃ and θ-Al₂O₃ phases have higher surface areas, and a metal powder for use in a washcoat solution of γ-Al₂O₃ and/or θ-Al₂O₃ will have a surface area of greater than 20 m²/g. It is conventionally believed that phases such as θ-alumina or γ-alumina are superior as a supporting structure for a deposited catalyst, as the greater surface per gram of θ-alumina or γ-alumina will allow for availability of more catalyst active sites than α-alumina. However, phases such as γ-Al₂O₃ and θ-Al₂O₃ are not thermally phase stable at temperatures of 800° C. to 1600° C. At such high temperatures, phases such as γ-Al₂O₃ and θ-Al₂O₃ will undergo phase transitions to higher stability phases. For example, at elevated temperatures, γ-Al₂O₃ will first convert to Δ-Al₂O₃ at roughly 750° C.; then Δ-Al₂O₃ will convert to θ-Al₂O₃ at roughly 950° C.; then θ-Al₂O₃ will then convert to α-Al₂O₃ with further exposure to elevated temperatures between 1000° C. and 1100° C. Thus, α-Al₂O₃ is the thermally phase stable version of Al₂O₃ at temperatures of 800° C. to 1600° C.

In various aspects, one option for adding a catalyst system to a monolith can be to coat the monolith with a mixture of a catalyst (optionally in oxide form) and metal oxide support layer. For example, powders of the catalyst oxide and the metal oxide support layer can be used to form a washcoat that is then applied to the monolith (or other structure). This can result in a catalyst system where the catalyst is mixed within/distributed throughout the metal oxide support layer, as opposed to the catalyst being deposited on top of the metal oxide support layer. In other words, at least a portion of the catalyst system can correspond to a mixture of the catalyst and the support layer. In other aspects, any convenient method for depositing or otherwise coating the catalyst system on the monolith or other structure can be used. The weight of the catalyst system on the monolith (or other structure) can correspond to 0.1 wt % to 10 wt % of the total weight of the catalyst system plus monolith, or 0.5 wt % to 10 wt %, or 2.0 wt % to 10 wt %, or 0.1 wt % to 6.0 wt %, or 0.5 wt % to 6.0 wt %, or 2.0 wt % to 6.0 wt %.

A catalyst system can be applied to a monolith or other structure, for example, by applying the catalyst system as a washcoat suspension. To form a washcoat suspension, the catalyst system can be added to water to form an aqueous suspension having 10 wt % to 50 wt % solids. For example, the aqueous suspension can include 10 wt % to 50 wt % solids, or 15 wt % to 40 wt %, or 10 wt % to 30 wt %. Optionally, an acid or a base can be added to the aqueous suspension to reduce or raise, respectively, the pH so as to change the particle size distribution of the alumina catalyst and/or binder particles. For example, acetic acid or another organic acid can be added to achieve a pH of 3 to 4. The suspension can then be ball milled (or processed in another manner) to achieve a desired particle size for the catalyst particles, such as a particle size of 0.5 μm to 5 μm. After milling, the suspension can be stirred until time for use so that the particles are distributed substantially uniformly in the solution.

The washcoat suspension can then be applied to a monolith structure to achieve a desired amount of catalyst (such as nickel or rhodium) on the monolith surface. As an example, in one aspect a washcoat thickness of 10 microns was achieved by forming a washcoat corresponding to 10 wt % of the monolith structure. Any convenient type of monolith structure can be used to provide a substantial surface area for support of the catalyst particles. The washcoat can be applied to the monolith to form cells having inner surfaces coated with the catalyst. One option for applying the washcoat can be to dip or otherwise submerge the monolith in the washcoat suspension.

After clearing the cell channels of excess washcoat, the catalyst system coated on the monolith can be optionally dried. Drying can correspond to heating at 100° C. to 200° C. for 0.5 hours to 24 hours. After any optional drying, calcination can be performed. In some aspects, calcining can correspond to heating at 200° C. to 800° C. for 0.5 hours to 24 hours. In some other aspects, calcining can correspond to heating at 800° C. to 1300° C. for 0.5 hours to 24 hours.

In other aspects, a high temperature calcination step can be used, so that the calcining temperature for the catalyst system coated on the monolith is substantially similar to or greater than the peak temperature the monolith will be exposed to during the cyclic high temperature reforming reaction. For a monolith in a high temperature zone, this can correspond to calcining the catalyst system coated on the monolith at a temperature of 800° C. or more, or 1000° C. or more, or 1200° C. or more, or 1300° C. or more, such as up to 1600° C. or possibly still higher. It is noted that if multiple catalyst zones are present, the calcination for monoliths in different catalyst zones can be different.

It has been unexpectedly discovered that performing calcination at a temperature similar to or greater than the peak temperature during the cyclic high temperature reforming process can unexpectedly allow for improved activity for the catalyst system and/or adhesion of the catalyst system to the underlying monolith. Without being bound by any particular theory, it is believed that exposing the monolith and deposited catalyst system to elevated temperatures prior to exposure of the catalyst to a cyclic reaction environment can facilitate forming a stable interface between the catalyst system and the monolith. This stable interface can then have improved resistance to the high temperature oxidizing and/or reducing environment during the reforming process, resulting in improved stability for maintaining the catalyst system on the surface of the monolith.

One of the distinctions between using a catalyst system including a thermally stable metal oxide and a catalyst system that does not use a thermally stable oxide is that the catalyst system including the thermally stable metal oxide can have improved adhesion to the underlying support structure after exposure to the cyclic high temperature reforming environment.

Adhesion of the washcoat after operation can be quantified by the amount of force needed to de-adhere the washcoat. In prior operation, washcoats comprised of theta and gamma alumina were de-adhered with minimal force, such as an amount of force similar to a paint brush stroke (weak). In operation with the phase stable supports, the force needed to de-adhere the washcoat was high, similar to the scraping of dried epoxy off of a glass surface (strong). Due to these differences, only small amounts of washcoat could be de-adhered from the phase stable materials, whereas large amounts of washcoat could be de-adhered from the gamma and theta supports.

Other methods for evaluating adhesion of the washcoat include, but are not limited to, (i) a thermal cycling method, (ii) a mechanical attrition method, and (iii) an air-knife method. As a non-limiting example, the thermal cycling method can be performed by heating the washcoated materials to high temperatures in the range of 800 to 1300° C., cooling the heated substrates to ambient temperature, and repeating such a cycle at least five times. As another non-limiting example, the mechanical attrition method can be performed by placing the washcoated materials inside a plastic container and shaking the container on a vibration table for at least 30 minutes.

In various aspects, suitable catalytic metals can include, but are not limited to, Ni, Co, Fe, Pd, Rh, Ru, Pt, Ir, Cu, Ag, Au, Zr, Cr, Ti, V, Mo, Nb, and combinations thereof. The catalytic metal can be selected based on the desired type of catalytic activity. Such catalytic metals may be used in a catalyst in the form of a metal oxide. In some aspects, for reforming of hydrocarbons in the presence of H₂O and/or CO₂ to make hydrogen, Ni, Rh, Ru, Pd, Pt, Ir, Cu, Co, or a combination of thereof can be suitable catalytic metals. The weight of catalytic metal oxide in the catalyst system can range from 0.1 wt % to 70 wt %, or 1.0 wt % to 60 wt %, or 2.0 wt % to 50 wt %, relative to the total weight of the catalyst system. In some aspects where the catalytic metal corresponds to a precious metal or noble metal, the weight of catalytic metal oxide in the catalyst system can range from 0.1 wt % to 10 wt %, or 0.2 wt % to 7.0 wt %, or 0.5 wt % to 4 wt %.

The catalytic metals can be selected to provide long term stable performance at specific temperature zones of the catalytic bed. This can allow for steady methane conversion, phase stability with the metal oxide support, and reduced or minimized sintering of catalytic metals. As an example involving three catalyst zones, the catalyst system in a highest temperature catalytic zone (e.g. 800˜1250° C.), which is exposed to some of highest temperatures and most severe temperature swings, can be composed of Ni as a catalytic metal (NiO as a catalytic metal oxide) and Al₂O₃ as a metal oxide support. It is noted that this catalyst system can at least partially convert to NiAl₂O₄ during portions of the cyclic reforming process. This catalyst system can be formed, for example, by using a mixture of NiO and Al₂O₃, as a washcoat on α-Al₂O₃ monoliths. In such an example, a catalyst system in a medium temperature catalytic zone (e.g. 600˜1150° C.) can be composed of Ni and Rh as catalytic metals (NiO and Rh₂O₃ as catalytic metal oxide), and Al₂O₃ as a metal oxide support. To form this catalyst system, a mixture of NiO and Rh₂O₃, as the catalytic material and Al₂O₃ (optionally but preferably α-Al₂O₃) as a metal oxide support material can be washcoated on a monolith comprising of 95 wt % α-Al₂O₃, 4 wt % SiO₂ and 1 wt % TiO₂. In such an example, a catalyst system in a low temperature catalytic zone (e.g. 400˜1050° C.) can be composed of Rh as catalytic metal (Rh₂O₃ as catalytic metal oxide) and α-Al₂O₃ as a metal oxide support. To form this catalyst system, a mixture of Rh₂O₃ and α-Al₂O₃ as the catalytic material can be washcoated on a monolith comprising 93 wt % α-Al₂O₃, 5 wt % SiO₂ and 2 wt % MgO.

In various aspects, suitable metals for the metal oxide support layer in the catalyst system can include, but are not limited to, Al, Si, Mg, Ca, Sr, Ba, K, Na, Ti, Zr, Hf, V, Nb, Ta, Cr, Mo, W, Mn, Fe, Ni, Co, Y, La, Ce, and combinations thereof. The metal (or metals) for the metal oxide support can be selected so that the metal oxide support substantially does not convert to metallic form under the reducing conditions present in the cyclic reaction environment. As an example, when the catalytic metal oxide is NiO, one option for a metal oxide support is Al₂O₃, preferably α-Al₂O₃. Another example of a suitable metal oxide support, optionally, in combination with NiO as the catalytic metal oxide, is a mixture of Al₂O₃ with SiO₂, MgO and/or TiO₂. In such an example, SiO₂ can combine with Al₂O₃ to form a mullite phase that could increase resistance to thermal shock and/or mechanical failure. Additionally or alternately, in such an example, MgO and/or TiO₂ can be added. The weight of metal oxide support in the catalyst bed can range from 1.0 wt % to 40 wt %, or 2.0 wt % to 30 wt %, or 3.0 wt % to 20 wt %, relative to the total weight of the monolith in the catalyst bed.

In various aspects, a metal oxide support layer (such as a thermally stable metal oxide support layer) can correspond to at least one oxide selected from the corundum group, stabilized zirconia, perovskite, pyrochlore, spinel, hibonite, zeolite, and mixtures thereof. The weight of metal oxide support can range from 1.0 wt % to 40 wt %, or 2.0 wt % to 30 wt %, or 3.0 wt % to 20 wt %, relative to the total weight of the monolith plus catalyst system.

One category of metal oxide support layers can correspond to traditional refractory oxides that are commonly used to form supported catalysts. For example, the metal oxide support can correspond to α-Al₂O₃, LaAlO₃, LaAl₁₁O₁₈, MgO, CaO, ZrO₂, TiO₂, CeO₂, Y₂O₃, La₂O₃, SiO₂, Na₂O, K₂O, and mixtures thereof. This group is defined herein as the “corundum” group of oxides, although many of the oxides in this group do not have the corundum lattice structure. For example, CeO₂ and MgO can both have a halite crystal structure. α-Al₂O₃ consists essentially of a dense arrangement of oxygen ions in hexagonal closest-packing with Al³⁺ ions in two-thirds of the available octahedral sites. LaAlO₃, often abbreviated as LAO, is an optically transparent ceramic oxide with a distorted perovskite structure. LaAl₁₁O₁₈ can be formed through the solid state reaction of LaAlO₃ and α-Al₂O₃. Plate-like crystals of LaAl₁₁O₁₈ are particularly useful as a metal oxide support since catalytic metals can be trapped between plate-like crystal structures. It suppresses sintering of minute catalytic metals in the active material which is washcoated on the monolith of the catalyst bed. Additional examples of oxides from the corundum group can include, but are not limited to: i) 95 wt % α-Al₂O₃ and 5 wt % SiO₂; ii) 93 wt % α-Al₂O₃, 5 wt % SiO₂ and 2 wt % MgO; iii) 94 wt % α-Al₂O₃, 4 wt % SiO₂, 2 wt % MgO and 1 wt % Na₂O; iv) 95 wt % α-Al₂O₃, 4 wt % SiO₂ and 1 wt % TiO₂; v) 7 wt % CeO₂ and 93 wt % MgO; vi) 5 wt % CaO and 95 wt % α-Al₂O₃; vii) 5 wt % MgO, 5 wt % CeO₂ and 90 wt % α-Al₂O₃; viii) 20 wt % ZrO₂ and 80 wt % CeO₂, ix) 5 wt % CeO₂, 20 wt % ZrO₂ and 75 wt % α-Al₂O₃, and x) 6 wt % La₂O₃ and 94 wt % α-Al₂O₃, based on the weight of metal oxide support.

As an example, the catalyst system can correspond to a mixture of NiO and Al₂O₃. Under the cyclic high temperature reforming conditions, the NiO and the Al₂O₃ in the will react to form a mixed phase of NiO, NiAl₂O₄, and/or Al₂O₃. Additionally, based on cyclic exposure to oxidizing and reducing conditions, the catalyst can be converted from a substantially fully oxidized state, such as a combination of oxides including NiO, NiAl₂O₄ and Al₂O₃, to various states including at least some Ni metal supported on a surface. In this discussion, a catalyst system that includes both NiO and Al₂O₃ is referred to as an NiAl₂O₄ catalyst system.

Based on the stoichiometry for combining NiO and Al₂O₃ to form NiAl₂O₄, a catalyst including a molar ratio of Al to Ni of roughly 2.0 (i.e., a ratio of 2:1) could result in formation of NiAl₂O₄ with no remaining excess of NiO or Al₂O₃. Thus, one option for forming an NiAl₂O₄ catalyst is to combine NiO and Al₂O₃ to provide a stoichiometric molar ratio of Al to Ni of roughly 2.0. In some other aspects, an excess of NiO can be included in the catalyst relative to the amount of alumina in the support, so that at least some NiO is present in a fully oxidized state. In such aspects, the molar ratio of Al to Ni in the catalyst can be less than 2.0. For example, the molar ratio of Al to Ni in a NiO/NiAl₂O₄ catalyst can be 0.1 to 2.0, or 0.1 to 1.9, or 0.1 to 1.5, or 0.5 to 2.0, or 0.5 to 1.9, or 0.5 to 1.5, or 1.0 to 2.0, or 1.0 to 1.9, or 1.2 to 1.5, or 1.5 to 2.0, or 1.5 to 1.9. In still other aspects, an excess of Al₂O₃ can be included in the catalyst relative to the amount of Ni, so that at least some Al₂O₃ is present in a fully oxidized state. In such aspects, the molar ratio of Al to Ni in the catalyst can be greater than 2.0. For example, the molar ratio of Al to Ni in a NiAl₂O₄/Al₂O₃ catalyst can be 2.0 to 10, or 2.1 to 10, or 2.0 to 5.0, or 2.1 to 5.0, or 2.0 to 4.0, or 2.1 to 4.0.

In various aspects, a NiAl₂O₄ catalyst can be incorporated, for example, into a washcoat that is then applied to a surface or structure within a reactor, such as a monolith. By providing NiO and Al₂O₃ as a catalyst system that is then deposited on a separate monolith (which can then form NiAl₂O₄ under the cyclic conditions), the activity of the catalyst can be maintained for unexpectedly longer times relative to using a monolith that directly incorporates NiO and Al₂O₃ into the monolith structure.

When a composition is formed that includes both nickel oxide and alumina, the NiO and Al₂O₃ can react to form a compound corresponding to NiAl₂O₄. However, when NiO (optionally in the form of NiAl₂O₄) is exposed to reducing conditions, the divalent Ni can be reduced to form metallic Ni. Thus, under cyclic reforming conditions that include both high temperature oxidizing and reforming environments, at least a portion of NiAl₂O₄ catalyst can undergo cyclic transitions between states corresponding to Ni metal and Al₂O₃ and NiAl₂O₄. It is believed that this cyclic transition between states can allow a NiAl₂O₄ catalyst to provide unexpectedly improved activity over extended periods of time. Without being bound by any particular theory, it is believed that at least part of this improved activity for extended time periods is due to the ability of Ni to “re-disperse” during the successive oxidation cycles. It is believed this re-dispersion occurs in part due to the formation of NiAl₂O₄ from NiO and Al₂O₃. Catalyst sintering is a phenomenon known for many types of catalysts where exposure to reducing conditions at elevated temperature can cause catalyst to agglomerate on a surface. Thus, even if the surface area of the underlying surface remains high, the agglomeration of the catalyst may reduce the amount of available catalyst active sites, as the catalyst sinters and forms lower surface area deposits on the underlying surface. By contrast, it is believed that the cyclic transition between states can allow the Ni in an NiAl₂O₄ catalyst system to retain good dispersion, so that catalyst activity can be maintained. It is believed that further advantage can be obtained by using a sufficient amount of excess oxygen during the regeneration step so that all available Ni is oxidized back to NiO and/or NiAl₂O₄.

It is noted that by supplying both NiO as a catalyst and Al₂O₃ as a metal oxide support layer as part of the catalyst system, the alumina for forming NiAl₂O₄ is already provided as part of the catalyst system. It is believed that this reduces or minimizes interaction of Ni with any alumina that may be present in the monolith composition, and therefore reduces or minimizes degradation of the underlying monolith when exposed to successive cycles of high temperature oxidation and reduction.

NiO supported on yttria-stabilized zirconia (NiO/YSZ) is another example of an Ni-containing catalyst system that can be used for reforming. Although α-Al₂O₃ is phase stable, it is able to react with NiO at high temperature to form NiAl₂O₄. It is believed, however, that YSZ does not react with Ni (NiO) at high temperatures. Thus, it is believed that in the NiO/YSZ system, a cyclic oxidation and reduction of Ni to NiO and back to Ni metal does occur, but redispersion does not occur. However, NiO/YSZ can still provide stable reforming activity in a cyclic high temperature reforming environment. In some aspects, to assist with bonding of NiO/YSZ to a monolith, an intermediate oxide layer of α-Al₂O₃ can first be deposited as a washcoat on the monolith. The NiO/YSZ layer can then be deposited on the intermediate oxide layer.

NiO/YSZ represents an alternative type of catalyst system, as YSZ is a phase stable support that does not react with Ni to form a different material. In order to determine stability of the support oxide layer, a first sample of NiO/YSZ was exposed to calcining at 1300° C., while a second sample was steamed in air at 1000° C. X-ray diffraction was used to verify that no phase changes occurred. However, based on Brunauer-Emmett-Teller (BET) surface area analysis, it was observed that the surface area of the NiO/YSZ sample was roughly 53 m²/g prior to the calcining and steaming, and roughly 5 m²/g after the calcining and steaming.

Still another example of a catalyst system containing Ni can be NiO on a perovskite oxide, such as Sr_{0.65}La_{0.35}TiO₃(SLT).

### Examples

A phenomenological reactor model was used to explore some examples of the use of such a passive temperature control and are listed below. In the simulations, the length of the catalytic zone was fixed (8″). To investigate the impact of using higher volumetric heat capacity, lower catalyst density regions, 1″ of the 8″ (e.g. 12.5% of the catalytic activity) was replaced with a blank higher heat capacity monolith (2 times the volumetric heat capacity of the base honeycomb monoliths). The 8″ of the catalytic zone are split into 4″ of Ni catalyst and 4″ of Rh based catalyst. It is noted that any convenient number of monoliths of any convenient size could be used in the catalytic zone.

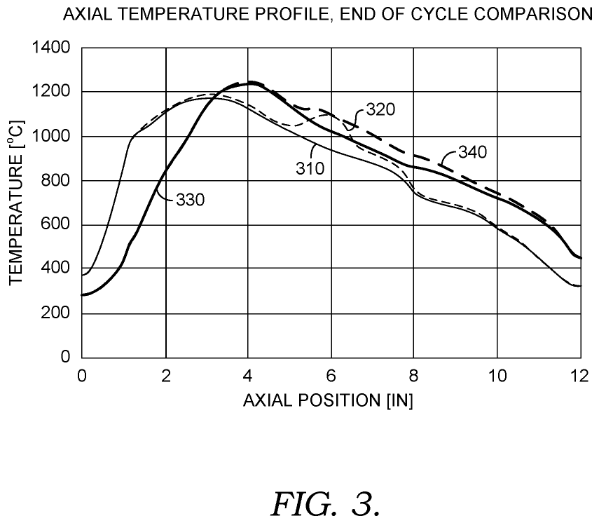

FIG. 3 shows the axial temperature profile along the reactor at the beginning and the end of the reforming step. Solid lines are the base case and dotted lines are the case with a high heat capacity, no catalyst region between 5.5-6.5″. The catalytic zone extends from 4-12 inches. This corresponds to inserting a region of high volumetric heat capacity and no catalyst density between two regions containing Ni catalyst density.

As shown by lines 310 (start of reforming) and 320 (end of reforming) in FIG. 3, the temperature across the entire reaction zone decreases by between 100° C. and 200° C. during the reforming step. By contrast, lines 330 (start of reforming) and 340 (end of reforming) show substantially different behavior when the reaction zone includes a region of high heat capacity and low catalyst density (such as no catalyst density), in this case between 5.5″ and 6.5″. As shown in FIG. 3, in the region of high volumetric heat capacity and low catalyst density, the temperature at the start of reforming is similar to the temperature at the end of reforming. This is due to the lack of catalysis of the reforming reaction in the region. Additionally, on either side of the region with high heat capacity and no catalyst density, and in particular on the downstream side, the temperature difference between the beginning of reforming and the end of reforming is reduced. As a result, the downstream portion of the reaction zone that conventionally operates at a colder temperature is able to maintain a higher average temperature throughout the reforming reaction step. Because of this higher temperature, even though there is no catalyst in the region of higher volumetric heat capacity, the higher temperatures downstream from the region of higher heat capacity can allow increased reforming to take place throughout the reforming steps. As a result, substantially the same amount of reforming can be achieved in the reactor at a similar peak temperature while using a reduced amount of catalyst.

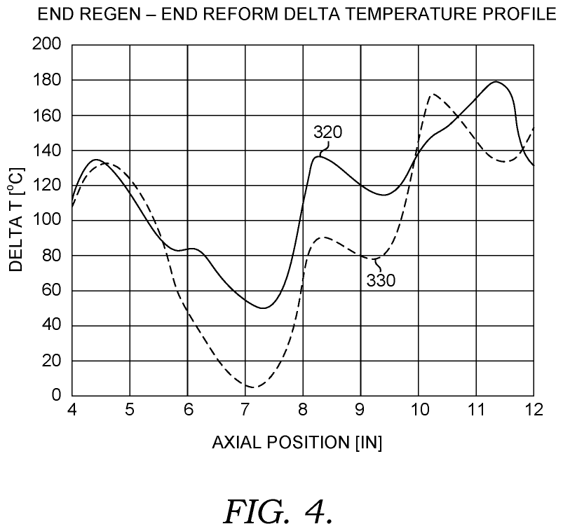

FIG. 4 shows the temperature delta between the beginning and end of the reforming step for the two simulated systems shown in FIG. 3: conventional system 410 and system 430 that includes a region of low catalyst density, high heat capacity. As shown in FIG. 4, the temperature swing during the reforming step is reduced by at least 50° C. relative to the conventional configuration. In addition to reducing the amount of catalyst, the reduction in thermal cycling that is enabled by the region of high volumetric heat capacity can reduce thermal degradation of catalyst, thereby extending catalyst lifetime.

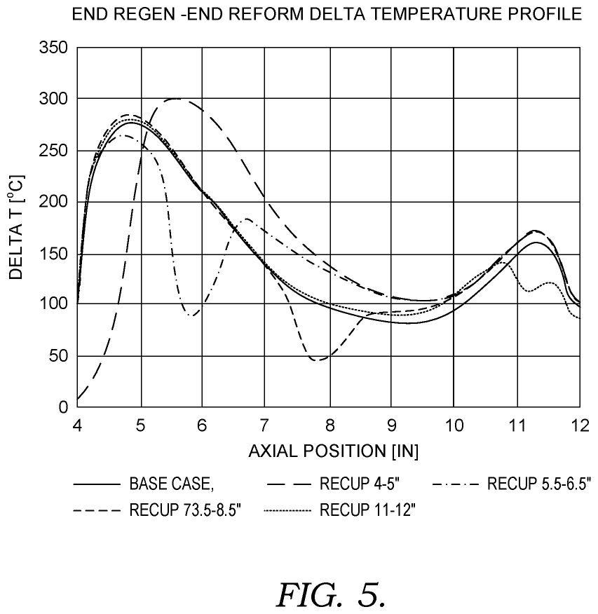

FIG. 3 and FIG. 4 show the impact on the temperature profile of placing a high heat capacity region at one location within a reactor. This modification of the temperature profile can also be implemented at other locations. FIG. 5 shows results similar to FIG. 4, but with the region of high heat capacity and no catalyst density being placed at different locations within the reaction zone. It is noted that in FIG. 5, all of the catalyst density in the simulation was selected to be rhodium. As shown in FIG. 5, by moving the location of the region of high heat capacity and low (such as no) catalyst density, it was possible to move the location where temperature swings during the reaction cycle were reduced or minimized.

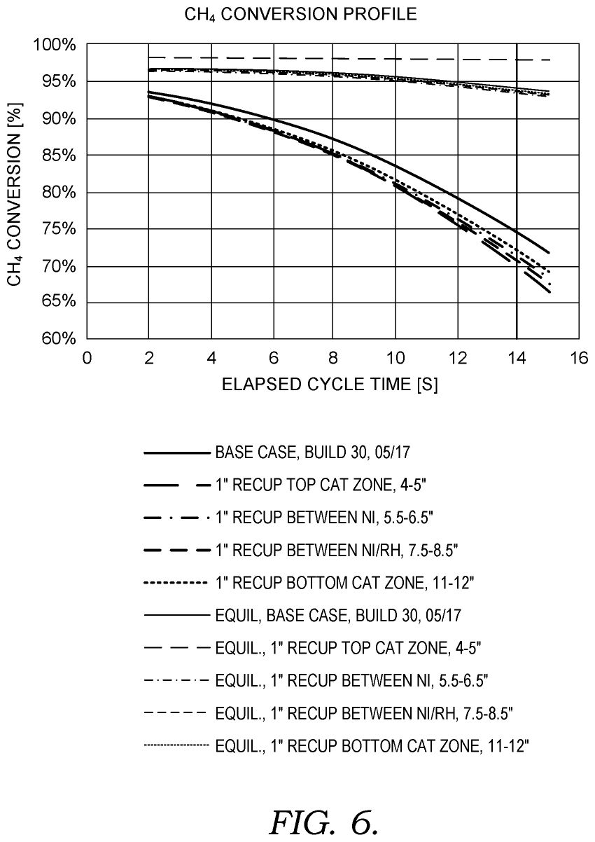

Additional simulations were performed for each of the configurations used in FIG. 5 to investigate how addition of a region of high volumetric heat capacity modifies the resulting reforming. In these additional simulations, the efficiency of methane reforming was characterized within a reaction cycle. Data was accumulated for both a single reaction cycle as well as after perform a sufficient number of reaction cycles to reach equilibrium for the methane reforming efficiency. FIG. 6 shows the results from the additional simulations.

As shown in FIG. 6, during the first reaction cycle in each configuration, addition of a region of high volumetric heat capacity with no catalyst density results in slight lowering of methane reforming efficiency relative to the base case of not having a high heat capacity region, regardless of where the region of high heat capacity is located. However, as the reactor approaches equilibrium, including a region of high volumetric heat capacity resulted in comparable methane reforming efficiency. Additionally, an improvement in overall reforming efficiency was provided by the configuration where the region of high volumetric heat capacity was included at the beginning of the reaction zone, so that substantially all of the catalyst in the reaction zone was downstream from the region of high heat capacity.

### Additional Embodiments

Embodiment 1. A reverse flow reactor system, comprising: a reaction zone comprising a reactant inlet, a flue gas outlet, and a plurality of regions, the plurality of regions comprising a first region of the plurality of regions comprising a first catalyst density and a first volumetric heat capacity, a second region comprising a second catalyst density and a second volumetric heat capacity, the second catalyst density being 20% or less of the first catalyst density, a ratio of the second volumetric heat capacity to the first volumetric heat capacity being 1.5 or more; a mixing zone adjacent to the reaction zone, the reaction zone comprising at least one reaction zone flow path providing fluid communication between the reactant inlet and the mixing zone; and a recuperation zone adjacent to the mixing zone, the mixing zone providing fluid communication between the reaction zone and the recuperation zone, the recuperation zone comprising a fuel inlet, an oxidant inlet, and a reaction effluent outlet.

Embodiment 2. The system of Embodiment 1, wherein the second region comprises substantially no catalyst density.

Embodiment 3. A reverse flow reactor system, comprising: a reaction zone comprising a reactant inlet, a flue gas outlet, and a plurality of regions, the plurality of regions comprising a first region of the plurality of regions comprising a first catalyst and a first volumetric heat capacity, a second region comprising a second catalyst different from the first catalyst and a second volumetric heat capacity, a ratio of the second volumetric heat capacity to the first volumetric heat capacity being 1.5 or more; a mixing zone adjacent to the reaction zone, the reaction zone comprising at least one reaction zone flow path providing fluid communication between the reactant inlet and the mixing zone; and a recuperation zone adjacent to the mixing zone, the mixing zone providing fluid communication between the reaction zone and the recuperation zone, the recuperation zone comprising a fuel inlet, an oxidant inlet, and a reaction effluent outlet.

Embodiment 4. The system of Embodiment 3, wherein the first region comprises a first catalyst density of the first catalyst, wherein the second region comprises a second catalyst density of the second catalyst, and wherein the second catalyst density is 20% or less of the first catalyst density.

Embodiment 5. The system of any of the above embodiments, wherein the second region is adjacent to the first region, or wherein the second region is adjacent to the mixing zone, or a combination thereof.

Embodiment 6. The system of any of the above embodiments, wherein the plurality of regions comprises a third region comprising a third catalyst density and a third volumetric heat capacity, the second region providing fluid communication between the first region and the third region, the second catalyst density being 20% or less of the third catalyst density, a ratio of the second volumetric heat capacity to the third volumetric heat capacity of 1.5 or more, the second region optionally being adjacent to the third region.

Embodiment 7. The system of any of the above embodiments, wherein the mixing zone comprises one or more mixing structure.

Embodiment 8. A method for converting hydrocarbons in a reverse flow reactor, comprising: mixing a fuel flow and a first O₂-containing flow in a mixing zone of a reactor system to form a mixture comprising an O₂ content of 0.1 vol % or more, the reactor system comprising a reforming zone, a mixing zone adjacent to the reforming zone, and a recuperation zone adjacent to the mixing zone, the mixing zone providing fluid communication between the reaction zone and the recuperation zone; reacting the mixture to heat one or more surfaces in the reforming zone to a reforming temperature, at least a portion of the reforming zone comprising a reforming catalyst; and exposing a reactant stream comprising one or more hydrocarbons to the reforming catalyst in the reforming zone under reforming conditions to form a reforming effluent, a direction of flow of the reactant stream being reversed relative to a direction of flow for the mixture, wherein the reaction zone comprises a plurality of regions, the plurality of regions comprising a first region of the plurality of regions comprising a first catalyst density of a first catalyst and a first volumetric heat capacity, a second region comprising a second catalyst density and a second volumetric heat capacity, the second catalyst density being 20% or less of the first catalyst density, a ratio of the second volumetric heat capacity to the first volumetric heat capacity being 1.5 or more.

Embodiment 9. The method of Embodiment 8, wherein the second region is adjacent to the first region, or wherein the second region is adjacent to the mixing zone, or a combination thereof.

Embodiment 10. The method of Embodiment 8 or 9, wherein the plurality of regions comprises a third region comprising a third catalyst density and a third volumetric heat capacity, the second region providing fluid communication between the first region and the third region, the second catalyst density being 20% or less of the third catalyst density, a ratio of the second volumetric heat capacity to the third volumetric heat capacity of 1.5 or more, the second region optionally being adjacent to the third region.

Embodiment 11. The method of any of Embodiments 8-10, wherein the second region comprises a second catalyst different from the first catalyst, or wherein the second region comprises substantially no catalyst density.

Embodiment 12. The method of any of Embodiments 8-11, wherein the reforming conditions comprise a peak temperature in the reforming zone of 1000° C. or less.

Embodiment 13. The method of any of Embodiments 8-12, wherein the mixing zone comprises one or more mixing structures.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A reverse flow reactor system, comprising:
a reaction zone comprising a reactant inlet, a flue gas outlet, and a plurality of regions, the plurality of regions comprising
a first region comprising a first catalyst density and a first volumetric heat capacity,
a second region comprising a second catalyst density and a second volumetric heat capacity, the second catalyst density being 20% or less of the first catalyst density, a ratio of the second volumetric heat capacity to the first volumetric heat capacity being 1.5 or more;
a mixing zone adjacent to the reaction zone, the reaction zone comprising at least one reaction zone flow path providing fluid communication between the reactant inlet and the mixing zone; and
a recuperation zone adjacent to the mixing zone, the mixing zone providing fluid communication between the reaction zone and the recuperation zone, the recuperation zone comprising a fuel inlet, an oxidant inlet, and a reaction effluent outlet.

2. The system of claim 1, wherein the second region is adjacent to the first region.

3. The system of claim 1, wherein the plurality of regions comprises a third region comprising a third catalyst density and a third volumetric heat capacity, the second region providing fluid communication between the first region and the third region, the second catalyst density being 20% or less of the third catalyst density, a ratio of the second volumetric heat capacity to the third volumetric heat capacity of 1.5 or more.

4. The system of claim 3, wherein the second region is adjacent to the third region.

5. The system of claim 1, wherein the second region is adjacent to the mixing zone.

6. The system of claim 1, wherein the second region comprises substantially no catalyst density.

7. The system of claim 1, wherein the mixing zone comprises one or more mixing structures.

8. A reverse flow reactor system, comprising:
a reaction zone comprising a reactant inlet, a flue gas outlet, and a plurality of regions, the plurality of regions comprising
a first region comprising a first catalyst and a first volumetric heat capacity,
a second region comprising a second catalyst different from the first catalyst and a second volumetric heat capacity, a ratio of the second volumetric heat capacity to the first volumetric heat capacity being 1.5 or more;
a mixing zone adjacent to the reaction zone, the reaction zone comprising at least one reaction zone flow path providing fluid communication between the reactant inlet and the mixing zone; and
a recuperation zone adjacent to the mixing zone, the mixing zone providing fluid communication between the reaction zone and the recuperation zone, the recuperation zone comprising a fuel inlet, an oxidant inlet, and a reaction effluent outlet.

9. The system of claim 8, wherein the second region is adjacent to the first region.

10. The system of claim 8, wherein the first region comprises a first catalyst density of the first catalyst, wherein the second region comprises a second catalyst density of the second catalyst, and wherein the second catalyst density is 20% or less of the first catalyst density.

11. The system of claim 10, wherein the plurality of regions comprises a third region comprising a third catalyst density and a third volumetric heat capacity, the second region providing fluid communication between the first region and the third region, the second catalyst density being 20% or less of the third catalyst density, a ratio of the second volumetric heat capacity to the third volumetric heat capacity of 1.5 or more.

12. The system of claim 11, wherein the second region is adjacent to the third region.

13. The system of claim 8, wherein the second region is adjacent to the mixing zone.

14. A method for converting hydrocarbons in a reverse flow reactor, comprising:
mixing a fuel flow and a first O₂-containing flow in a mixing zone of a reactor system to form a mixture comprising an O₂ content of 0.1 vol % or more, the reactor system comprising a reforming zone, a mixing zone adjacent to the reforming zone, and a recuperation zone adjacent to the mixing zone, the mixing zone providing fluid communication between the reaction zone and the recuperation zone;
reacting the mixture to heat one or more surfaces in the reforming zone to a reforming temperature, at least a portion of the reforming zone comprising a reforming catalyst; and
exposing a reactant stream comprising one or more hydrocarbons to the reforming catalyst in the reforming zone under reforming conditions to form a reforming effluent, a direction of flow of the reactant stream being reversed relative to a direction of flow for the mixture,
wherein the reaction zone comprises a plurality of regions, the plurality of regions comprising
a first region comprising a first catalyst density of a first catalyst and a first volumetric heat capacity,
a second region comprising a second catalyst density and a second volumetric heat capacity, the second catalyst density being 20% or less of the first catalyst density, a ratio of the second volumetric heat capacity to the first volumetric heat capacity being 1.5 or more.

15. The method of claim 14, wherein the second region is adjacent to the first region, or wherein the second region is adjacent to the mixing zone, or a combination thereof.

16. The method of claim 14, wherein the plurality of regions comprises a third region comprising a third catalyst density and a third volumetric heat capacity, the second region providing fluid communication between the first region and the third region, the second catalyst density being 20% or less of the third catalyst density, a ratio of the second volumetric heat capacity to the third volumetric heat capacity of 1.5 or more.

17. The method of claim 16, wherein the second region is adjacent to the third region.

18. The method of claim 14, wherein the second region comprises a second catalyst different from the first catalyst, or wherein the second region comprises substantially no catalyst density.

19. The method of claim 14, wherein the reforming conditions comprise a peak temperature in the reforming zone of 1000° C. or less.

20. The method of claim 14, wherein the mixing zone comprises one or more mixing structures.
